(19) United States
(12) Patent Application Publication
(10) Pub. No.: US 2015/0113531 A1
(43) Pub. Date: Apr. 23, 2015

(54) SYSTEM FOR MIGRATING VIRTUAL MACHINE AND METHOD THEREOF

(71) Applicant: POWER-ALL NETWORKS LIMITED, Shatin (HK)

(72) Inventors: JUN LV, Shenzhen (CN); YUN-JIE XU, Shenzhen (CN); JIAN-PING ZHANG, Shenzhen (CN); MENG-MING HUANG, Shenzhen (CN)

(21) Appl. No.: 14/512,196

(22) Filed: Oct. 10, 2014

(30) Foreign Application Priority Data
Oct. 18, 2013 (CN) 201310493950.8

(51) Int. Cl. G06F 9/48

(52) U.S. Cl. CPC G06F 9/4856
USPC 718/1

(57) ABSTRACT

A method for migrating a virtual machine (VM) includes: receiving a migrate request to migrate a VM of a first cloud node, obtaining configuration information of the VM of the first node and a target address, and generating a parameter file including the configuration information of the VM; obtaining system information of the VM of the first node, and creating an image file according to the system information; packeting the parameter file and the image file of the VM of the first node to obtain a packet file, and storing the packet file into a storage server of the first cloud node; transmitting the packet file to a storage server of a second cloud node according to the target address; and creating a new VM in a platform server of the second cloud node according to the configuration information and restoring the image file to the created VM.

### CROSS-REFERENCE TO RELATED APPLICATIONS

This application claims priority to Chinese Patent Application No. 201310493950.8 filed on Oct. 18, 2013 in the China Intellectual Property Office, the contents of which are incorporated by reference herein.

### FIELD

The present disclosure relates to management systems, and particularly to a system for migrating virtual machine, and a method thereof

### BACKGROUND

Nowadays, data, such as audios, videos, pictures can be transmitted from one place to another place via networks, such as Internet. However, a virtual machine located in one place (such as New York) is difficult to be migrated to another place (such as Philadelphia).

### BRIEF DESCRIPTION OF THE DRAWINGS

Implementations of the present technology will now be described, by way of example only, with reference to the attached figures.

FIG. 1 is a block diagram of a system for migrating virtual machine.

FIG. 2 is a hardware environment for running the system for migrating virtual machine.

FIG. 3 is a flowchart diagram of an embodiment of a method for migrating virtual machine.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

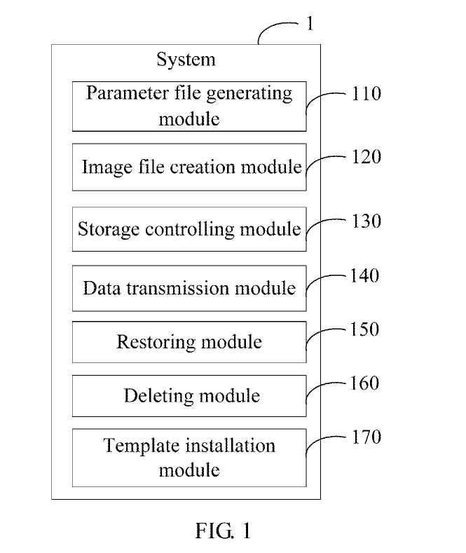

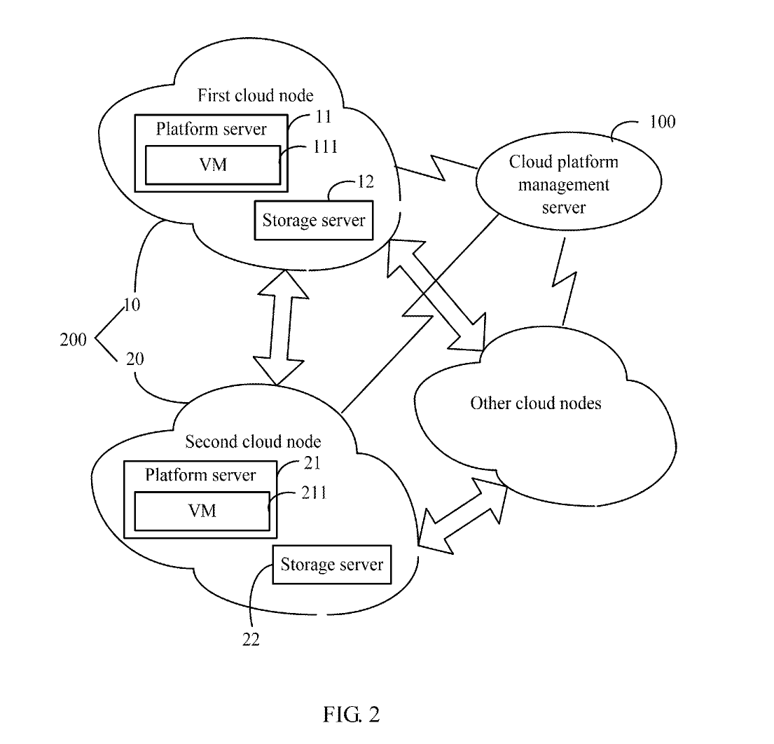

Referring to FIG. 1 and FIG. 2, a system 1 for migrating a virtual machine (VM) is illustrated. The system 1 is run in an environment which includes at least one cloud platform management server 100 and a number of cloud nodes 200 as shown in FIG. 2. The cloud platform management server 100 can communicate with the cloud nodes 200 and manage the cloud node vices 200.

The cloud nodes 200 at least include a first cloud node 10, a second cloud node 20, and other cloud nodes (not labeled). Each cloud node 200 is located in corresponding area, specially, located in a corresponding geographic area. For example, the first cloud node 10 is located in New York, and the second cloud node 20 is located in Philadelphia. Each cloud node 200 includes a platform server and a storage server. For example, the first cloud node 10 includes a platform server 11 and a storage server 12. The second cloud node 20 includes a platform server 21 and a storage server 22. The platform server 11 can establish at least one VM 111 based on a corresponding virtual platform, such as a XEN platform (an open source enterprise-ready server virtualization and cloud computing platform) or a Kernel-based Virtual Machine (KVM) platform. The platform server 21 also can establish at least one VM 211 based on a corresponding virtual platform. The virtual platforms for the platform server 11 and the platform server 21 can be the same or different.

The system 1 is used to migrate a VM of one cloud node 200 to another cloud node 200. For example, the system 1 can migrate the VM 111 of the platform server 11 of the first cloud node 10 of to the platform server 21 of the second cloud node 20. In detail, the system 1 can obtain configuration information of the VM 111 which is to be migrated and create an image file of the VM, and packet the configuration information and the image file of the VM to obtain an packet file, and then store the packet file to the storage server 12 of the first cloud node 10. The system 1 further can transmit the packet file to the storage server 22 of the second cloud node 10 via a network, such as a virtual lease line, a Internet or the like. The system 1 further can establish a new bare VM in the platform server 21 of the second cloud node 20, and restore the image file to the new bare VM according to the packet file to generate a VM which is the same as the VM 111, thus to achieve the function of migrating the VM 111 of the first cloud node 10 to the second cloud node 20.

The cloud platform management server 100 includes a communication unit 101, a processing unit 102, and a storage unit 103. The configuration management server 100 communicates with the platform server and the storage server of each cloud node 200 via the communication unit 101. For example, the configuration management server 100 communicates with the platform server 11, the storage server 12 of the first cloud node 10 and the platform server 21, the storage server 22 of the second cloud node 20 via the communication unit 101.

Each platform server includes a processing unit 104 and a storage unit 105. For example, the platform server 11 of the first cloud node 10 and the platform server 21 of the second cloud node 20 both include the processing unit 104 and the processing unit 105.

In the embodiment, each of the cloud platform management server 100, the platform servers 11, 21, and the storage servers 12, 22 can be a single server or a server group.

The system 1 includes a parameter file generating module 110, an image file creation module 120, a storage controlling module 130, a data transmission module 140, a restoring module 150, a deleting module 160, and a template installation module 170.

In the embodiment, the parameter file generating module 110, the image file creation module 120, the storage controlling module 130, the data transmission module 140, the deleting module 160, and the template installation module 170 can be a collection of software instructions stored in the storage unit 103 of the cloud platform management server 100 and executed by the processing unit 102 of the cloud platform management server 100. The restoring module 150 can be a collection of software instructions stored in the storage unit 105 of each platform server (such as each of the first platform server 11 and second platform server 21) and executed by the processing unit 104 of each platform server. The modules of the system 1 also can include functionality represented as hardware or integrated circuits, or as software and hardware combinations, such as a special-purpose processor or a general-purpose processor with special-purpose firmware.

In another embodiment, the all of modules of the system 1 can be stored in the storage unit 103 of the cloud platform management server 100 and executed by the processing unit 102 of the cloud platform management server 100.

In one embodiment, each one of the processing units 102 and 104 can be a central processing unit, a digital signal processor, or a single chip, for example. In one embodiment, each one of the storage units 103 and 105 can be an internal storage system, such as a flash memory, a random access memory (RAM) for temporary storage of information, and/or a read-only memory (ROM) for permanent storage of information. Each one of the storage units 103 and 105 can also be a storage system, such as a hard disk, a storage card, or a data storage medium. Each one of the storage units 103 and 105 can include volatile and/or non-volatile storage devices. In at least one embodiment, each one of the storage units 103 and 105 can include two or more storage devices such that one storage device is a memory and the other storage device is a hard drive.

In the embodiment, to simply the description of the present invention, migrating the VM 111 of the first cloud node 10 to the second cloud node 20 is taken as an example. In the embodiment, the storage unit 103 of the cloud platform management device 100 further stores unique identifiers of a number of VM and configuration information, system information corresponding to different unique identifiers.

The parameter file generating module 110 is used to receive a migrate request to migrate the VM 111 of the first cloud node 10 and obtain configuration information of the VM 111 to be migrated and a target address in response to the migrate request, and generate a parameter file at least including the configuration information of the VM 111. In the embodiment, the migrate request includes a unique identifier of the VM 111 to be migrated and the target address, the parameter file generating module 110 obtain obtains the unique identifier of the VM 111 included in the migrate request, and obtains the configuration information of the VM 111 corresponding to the unique identifier of the VM 111 from the storage unit 103. The parameter file generating module 110 can obtain the target address from the migrate request directly.

In the embodiment, a user can log in a management interface (not shown) provided by the cloud platform management device 100, and input the unique identifier of the VM 111 to be migrated and the target address via the management interface to submit the migrate request. In the embodiment, the configuration information of the VM 111 can include, but not limited to a type of a central processing unit (CPU) of the VM 111, a size of a memory of the VM 111, an amount of logical disks of the VM 111. The target address can be a network address of the second cloud node 20, for example, is a network address of the storage server 22 of the second cloud node 20. The network address can be a Internet protocol (IP) address.

The image file creation module 120 is used to obtain the system information of the VM 111 to be migrated and create an image file according to the system information. In the embodiment, the image file creation module 120 determines the system information corresponding to the unique identifier of the VM 111 to be migrated, and then obtains the system information of the VM 111. In the embodiment, the system information includes information of an operating system, applications, and user data of the VM 111.

The storage controlling module 130 is used to packet the parameter file and the image file of the VM 111 to be migrated to obtain a packet file, and store the packet file into the storage server 12 of the first cloud node 10.

The data transmission module 140 is used to transmit the packet file to the storage server 22 of the second cloud node 20 according to the target address, namely the network address of the storage server 22 of the second cloud node 20, via a network, such as the virtual lease line, the Internet, a telecommunication network including a general packet radio service (GPRS) network and a code division multiple access (CDMA) network, a broadcasting network, or the like.

The restoring module 150 is used to create a new VM 211 in the platform server 21 of the second cloud node 20 according to the configuration information included in the packet file which is stored in the storage server 22 and restore the image file included in the packet file to the created VM, thus to migrate the VM 111 of the first cloud node 10 to the platform server 21 of the second cloud node 20. That is, after the image file is restored in the created VM 211, the VM 211 is substantially the same as the VM 111 and can be taken as the VM 111, thus the VM 111 of the first cloud node 10 is migrated to the second cloud node 20.

The deleting module 160 is used to delete the packet file stored in the storage servers 12 and 22 after the VM 111 is migrated from the first cloud node 10 to the second cloud node 20.

The template installation module 17 is used to install a template file on the VM 111 before migrating the VM 111. In the embodiment, the template file packets a number of drive files supporting a number of virtual platform, such as a drive file supporting the XEN virtual platform, or a drive file supporting the KVM platform. The parameter file generated by the parameter file generating module 110 further includes the template file. Thus the packet file obtained by the storage controlling module 130 also includes the template file.

In one embodiment, after the restoring module 150 creates the new VM 211 in the platform server 21 of the second cloud node 20 and restores the image file included in the packet file to the created VM, the template file is stored in the new VM 211. If the VM 211 is being started up, the restoring module 150 further determines which virtual platform used by the platform server 21 of the second cloud node 20, and determines a drive file supporting the determined virtual platform, and then starts up and run the VM 211 according to the determined drive file.

For example, assume the VM 111 to be migrated belongs to the XEN platform (namely, the platform server 11 establishes the VM 111 based on the XEN platform), and the virtual platform applied/used by the platform server 21 is the KVM platform. After the restoring module 150 restores the image file to the VM 211 of the platform server 21, if the VM 211 is being started up, the restoring module 150 can start up and run the VM 211 by using the drive file supporting the KVM platform. Therefore, the VM 111 can be migrated to another cloud node device 200 with another virtual platform and can be normally run by another cloud node device 200 with another virtual platform.

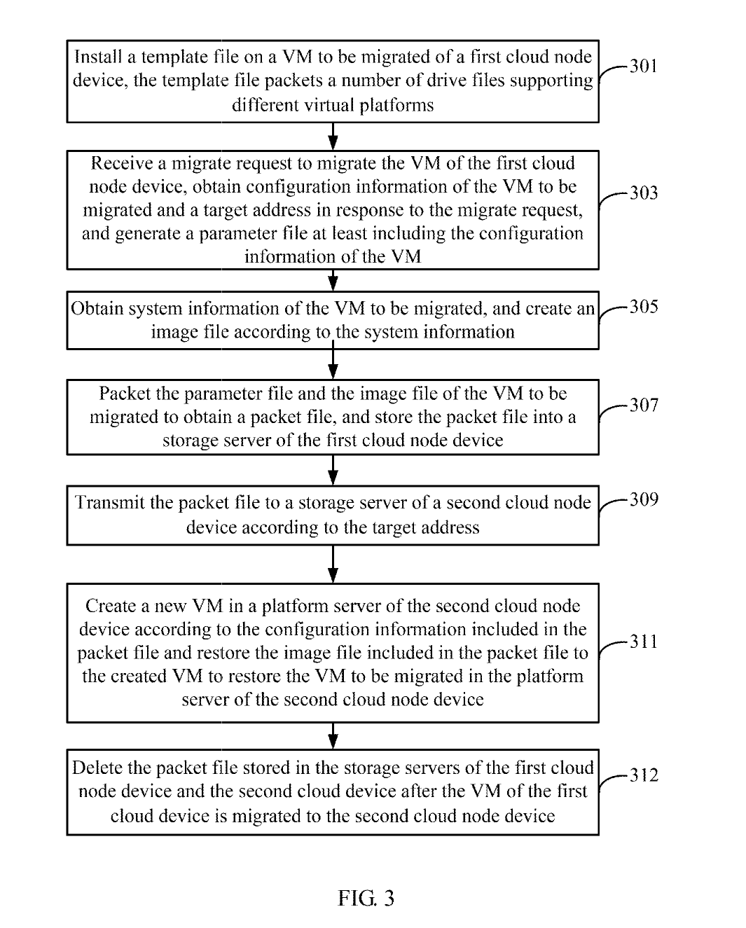

FIG. 3 illustrates a flowchart of the gateway configuration management method. The method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines carried out in the example method. Additionally, the illustrated order of blocks is by example only and the order of the blocks can be changed. The example method can begin at block 301.

In block 301, a template installation module installs a template file on a VM to be migrated of a first cloud node, wherein, the template file packets a number of drive files supporting different virtual platforms.

In block 303, a parameter file generating module receives a migrate request to migrate the VM of the first cloud node and obtain configuration information of the VM to be migrated and a target address in response to the migrate request, and generate a parameter file at least including the configuration information of the VM. In detail, the migrate request includes a unique identifier of the VM to be migrated and the target address, the parameter file generating module obtains the unique identifier of the VM and the target address included in the migrate request, and obtains the configuration information of the VM corresponding to the unique identifier of the VM from a cloud platform management server which stores a number of configuration information corresponding to different unique identifiers.

In block 305, an image file creation module obtains system information of the VM to be migrated, and creates an image file according to the system information, the system information at least includes information of an operating system, applications, and user data of the VM to be migrated. In the embodiment, the image file creation module obtains the system information of the VM to be migrated according to the unique identifier of the VM from the cloud platform management server which further stores a number of system information corresponding to different unique identifiers.

In block 307, a storage controlling module packets the parameter file and the image file of the VM to be migrated to obtain a packet file, and store the packet file into a storage server of the first cloud node.

In block 309, a data transmission module transmits the packet file to a storage server of a second cloud node according to the target address. In the embodiment, the target address can be a network address of the storage server of the second cloud node.

In block 311, a restoring module creates a new VM in a platform server of the second cloud node according to the configuration information included in the packet file which is stored in the storage server of the second cloud node and restore the image file included in the packet file to the created VM, thus to migrate the VM from the first cloud node to the second cloud node.

In block 312, a deleting module deletes the packet file stored in the storage server of the first cloud node and the storage server of the second cloud node after the VM is migrated from the first cloud node to the second cloud node.

In the embodiment, the method can further include: when the VM migrated to the second cloud node is being started up, the restoring module further determines which virtual platform used by the platform server of the second cloud node, and obtain a drive file supporting the determined virtual platform from the template file, and then starts up and run the VM according to the determined drive file.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for migrating a virtual machine (VM) comprising:
one or more processing units;
a plurality of modules which are collections of instructions executed by the processing unit, the plurality of modules comprising:
a parameter file generating module configured to receive a migrate request to migrate a VM of a first cloud node, and obtain configuration information of the VM of the first cloud node and a target address in response to the migrate request, and generate a parameter file comprising at least the configuration information of the VM of the first cloud node;
an image file creation module configured to obtain system information of the VM of the first cloud node, and create an image file according to the system information, wherein the system information comprises at least information of an operating system, applications, and user data of the VM of the first node; and
a storage controlling module configured to packet the parameter file and the image file of the VM of the first node to obtain a packet file, and store the packet file into a storage server of the first cloud node;
a data transmission module configured to transmit the packet file to a storage server of a second cloud node according to the target address, wherein the target address is a network address of the storage server of the second cloud node; and
a restoring module configured to create a new VM in a platform server of the second cloud node according to the configuration information included in the packet file and restore the image file included in the packet file to the created VM, thus to migrate the VM of the first cloud to the platform server of the second cloud node.

2. The system according to claim 1, wherein the migrate request comprises a unique identifier of the VM of the first cloud node and the target address, the parameter file generating module obtains the unique identifier of the VM of the first cloud node and the target address included in the migrate request, and obtains the configuration information of the VM of the first cloud node corresponding to the unique identifier of the VM from a cloud platform management server which stores a number of configuration information corresponding to different unique identifiers.

3. The system according to claim 2, wherein the image file creation module obtains the system information of the VM of the first cloud node according to the unique identifier of the VM of the first cloud node from the cloud platform management server which further stores a number of system information corresponding to different unique identifiers.

4. The system according to claim 1, wherein modules further comprise a template installation module configured to install a template file on the VM of the first cloud node before migrating the VM of the first cloud node, wherein the template file packets a number of drive files supporting different virtual platforms; after the restoring module creates the new VM in the platform server of the second cloud node and restores the image file included in the packet file to the created VM, the template file is installed in the VM already migrated to the platform server of the second cloud node; if the VM is being started up, the restoring module further determines which virtual platform is applied by the platform server of the second cloud node, and obtain a drive file supporting the determined virtual platform from the template file, and then starts up and run the VM migrated to the platform server of the second cloud node according to the determined drive file.

5. The system according to claim 1, wherein the modules further comprises a deleting module configured to delete the packet file stored in the storage servers of the first cloud node and the second cloud device after the VM of the first cloud device is migrated to the second cloud node.

6. A method for migrating a virtual machine (VM) comprising:
receiving a migrate request to migrate a VM of a first cloud node, obtaining configuration information of the VM of the first cloud node and a target address in response to the migrate request, and generating a parameter file at least comprising the configuration information of the VM of the first cloud node;
obtaining system information of the VM of the first cloud node, and creating an image file according to the system information, wherein the system information at least comprises information of an operating system, applications, and user data of the VM of the first cloud node;
packeting the parameter file and the image file of the VM of the first cloud node to obtain a packet file, and storing the packet file into a storage server of the first cloud node;
transmitting the packet file to a storage server of a second cloud node according to the target address, wherein the target address is a network address of the storage server of the second cloud node; and
creating a new VM in a platform server of the second cloud node according to the configuration information included in the packet file and restoring the image file included in the packet file to the created VM to migrate the VM of the first cloud node to the platform server of the second cloud node.

7. The method according to claim 6, wherein the migrate request comprises a unique identifier of the VM of the first node and the target address, the step of obtaining configuration information of the VM of the first node and a target address in response to the migrate request comprises:
obtaining the unique identifier of the VM and the target address included in the migrate request; and
obtaining the configuration information of the VM corresponding to the unique identifier of the VM from a cloud platform management server which stores a number of configuration information corresponding to different unique identifiers.

8. The method according to claim 7, wherein the step of obtaining system information of the VM of the first node comprises:
obtains the system information of the VM of the first node according to the unique identifier of the VM from the cloud platform management server which further stores a number of system information corresponding to different unique identifiers.

9. The method according to claim 6, further comprising:
installing a template file on the VM of the first cloud node prior to migrate the VM of the first cloud node, wherein the template file packets a number of drive files supporting different virtual platforms;
determining which virtual platform is applied by the platform server of the second cloud node when the VM is being started up after the VM of the first cloud node is migrated to the platform server of the second cloud node;
obtaining a drive file supporting the determined virtual platform from the template file; and
starting up and running the VM migrated to the platform server of the second cloud node according to the determined drive file.

10. The method according to claim 6, further comprising:
deleting the packet file stored in the storage servers of the first cloud node and the second cloud device after the VM of the first cloud device is migrated to the second cloud node.

11. A non-transitory storage medium having stored thereon instructions that, when executed by at least one processor, causes the least one processor to execute instructions of a method for automatically migrating a virtual machine (VM) from a first cloud node to a second cloud node, the method comprising:
receiving a migrate request to migrate the VM of the first cloud node, obtaining configuration information of the VM of the first node and a target address in response to the migrate request, and generating a parameter file at least comprising the configuration information of the VM;
obtaining system information of the VM of the first node, and creating an image file according to the system information, wherein the system information at least comprises information of an operating system, applications, and user data of the VM of the first node;
packeting the parameter file and the image file of the VM of the first node to obtain a packet file, and storing the packet file into a storage server of the first cloud node;
transmitting the packet file to a storage server of the second cloud node according to the target address, wherein the target address is a network address of the storage server of the second cloud node; and
creating a new VM in a platform server of the second cloud node according to the configuration information included in the packet file and restoring the image file included in the packet file to the created VM to migrate the VM of the first node to the platform server of the second cloud node.

12. The non-transitory storage medium according to claim 11, wherein the migrate request comprises a unique identifier of the VM of the first node and the target address, the step of obtaining configuration information of the VM of the first node and a target address in response to the migrate request comprises:
obtaining the unique identifier of the VM and the target address included in the migrate request; and
obtaining the configuration information of the VM corresponding to the unique identifier of the VM from a cloud platform management server which stores a number of configuration information corresponding to different unique identifiers.

13. The non-transitory storage medium according to claim 12, wherein the step of obtaining system information of the VM of the first node comprises:
obtains the system information of the VM of the first node according to the unique identifier of the VM from the cloud platform management server which further stores a number of system information corresponding to different unique identifiers.

14. The non-transitory storage medium according to claim 11, the method further comprising:
installing a template file on the VM of the first cloud node prior to migrate the VM of the first cloud node, wherein the template file packets a number of drive files supporting different virtual platforms;
determining which virtual platform is applied by the platform server of the second cloud node when the VM is being started up after the VM of the first cloud node is migrated to the platform server of the second cloud node;
obtaining a drive file supporting the determined virtual platform from the template file; and
starting up and running the VM migrated to the platform server of the second cloud node according to the determined drive file.

15. The non-transitory storage medium according to claim 11, the method further comprising:
deleting the packet file stored in the storage servers of the first cloud node and the second cloud device after the VM of the first cloud device is migrated to the second cloud node.
